(19) United States
(12) Patent Application Publication
(10) Pub. No.: US 2005/0206516 A1
(43) Pub. Date: Sep. 22, 2005

(54) Microwave sensor

(76) Inventor: Masatoshi Tsuji, Otsu (JP)

Correspondence Address: WENDEROTH, LIND & PONACK, L.L.P., 2033 K STREET N. W., SUITE 800, WASHINGTON, DC, 20006-1021, US

(21) Appl. No.: 11/081,597

(22) Filed: Mar. 17, 2005

(30) Foreign Application Priority Data
Mar. 18, 2004 (JP) 2004-78804

(51) Int. Cl. G08B 19/00

(52) U.S. Cl. 340/522

(57) ABSTRACT

According to one embodiment, a microwave sensor that transmits microwaves toward a detection area, performs an object detecting operation based on reflected waves from an object being present in the detection area, and outputs an object detection signal based on a result of the object detecting operation is provided with a detecting operation controller for letting the object detecting operation performed intermittently at a predetermined detection cycle, a random number generator for generating a random number, and a time setting changer for randomly changing time settings of the detection cycle within a predetermined range, based on the random number generated by the random number generating portion.

### CROSS-REFERENCE TO RELATED APPLICATION

The present application claims the priority under 35 U.S.C. §119(a) on patent application No. 2004-78804, filed in Japan on Mar. 18, 2004, the subject matter of which is hereby incorporated herein by reference.

### BACKGROUND OF THE INVENTION

1. Field of Invention

The present invention relates to a microwave sensor that is an active sensor using electromagnetic waves whose frequency is lower than that of visible light. In particular, the present invention relates to a microwave sensor that can suppress an influence of mutual interference between their radio waves in the case where a plurality of microwave sensors are arranged close to each other.

2. Conventional Art

Conventionally, as one of crime prevention devices, microwave sensors are known in which microwaves are emitted toward a detection area, and when a human figure is present in the detection area, the human figure (intruder) is detected by receiving the reflected waves (microwaves modulated due to the Doppler effect) from the human figure.

Such a microwave sensor is provided with an antenna for emitting and receiving microwaves. Microwaves are emitted from the antenna toward a detection area, and when a human figure is present in the detection area, the reflected waves from the human figure with the frequency modulated due to the Doppler effect are received by the antenna. More specifically, in this case, the microwaves received by the antenna are modulated with respect to the frequency of the microwaves emitted from the antenna, so that the waveforms of an output signal from the microwave sensor is changed, and thus a human figure detection signal is emitted from the microwave sensor.

Generally, this type of microwave sensor is used in combination with a passive infrared sensor (PIR sensor) in which an infrared ray from a human figure in a detection area is received, and the intruder is detected based on a temperature difference between the human figure and its surroundings (see JP H11-39574A, for example). More specifically, the detection area of the microwave sensor and the detection area of the passive infrared sensor are overlapped, and the AND of their detection outputs is taken so as to supplement weaknesses of the two sensors, so that the reliability of human figure detection is enhanced.

When a plurality of such microwave sensors are arranged in the same space or one in each adjacent space, radio waves emitted from the microwave sensors may interfere each other. Normally, the antennas of microwave sensors are arranged to extend vertically in the state where sensors are installed. When a pair of the thus configured sensors are arranged, for example, on wall surfaces opposed to each other in the same room, the planes of polarization of the antennas of the microwave sensors overlap each other on the same plane, and thus their radio waves interfere each other. Consequently, a noise is mixed in the waveforms of output signals from the microwave sensors, and thus a normal operation may be impaired. Furthermore, even when the microwave sensors are arranged one in each adjacent room, if the wall surfaces on which the microwave sensors are arranged are opposed to each other, their radio waves interfere each other in a similar manner to the above because microwaves are transmitted through walls, and thus a normal operation may be impaired.

FIG. 4 is a block diagram showing a circuit configuration of such a conventional microwave sensor 100.

As shown in FIG. 4, the microwave sensor 100 is provided with an oscillation power source 26 for oscillating microwaves, a transmitting antenna 22 for transmitting the microwaves oscillated by the oscillation power source 26 toward a detection area, a receiving antenna 21 for receiving the reflected waves of the microwaves reflected by a human figure or the like, a mixer 23 for mixing the microwaves received by the receiving antenna 21 and the voltage waveforms of the oscillation power source 26 and outputting the result, an IF amplifier 25 for amplifying the output of the mixer 23, a microprocessor 110 for controlling the entire microwave sensor 100, and an oscillation circuit 11 for supplying a clock signal CLK to the microprocessor 110. It should be noted that for the oscillation circuit 11, for example, a ceramic oscillator or a crystal oscillator can be used, but the oscillator is not limited to these.

Furthermore, a switch 24a is inserted between the mixer 23 and the IF amplifier 25, and a switch 24b is inserted between the transmitting antenna 22 and the oscillation power source 26. The switches 24a and 24b can switch an electrical connection state in response to an external signal, and are connected so as to be switchable in synchronization.

The microprocessor 110 has a switching control portion 10a for outputting a switching control signal S0 that controls switching of the switches 24a and 24b, a timer 10b for determining the cycle of the switching control signal S0 that is output from the switching control portion 10a, and a time setting portion 10c for setting a detection cycle (for example, 250 μs) for the timer 10b. For the ON time of the switching control signal S0 in each cycle, a necessary time can be ensured by using, for example, another timer (not shown) or a software timer.

The microprocessor 110 generates a system clock by dividing the clock signal CLK supplied from the oscillation circuit 11, and operates each portion of the microprocessor 110 based on the system clock. Since the timer 10b also operates based on the system clock, the accuracy of time of the timer 10b depends on the accuracy of the system clock or the clock signal CLK of the oscillation circuit 11 from which the system clock is generated.

When the switching control signal S0 that is output from the switching control portion 10a is ON, both of the switches 24a and 24b are switched to be electrically connected, and thus the microwave sensor 100 performs an operation of detecting a human figure or the like. More specifically, microwaves are transmitted from the transmitting antenna 22 toward a detection area, and when a human figure or the like is present in the detection area, the reflected waves from the human figure with the frequency modulated due to the Doppler effect are received by the receiving antenna 21. The received reflected waves are mixed with the voltage waveforms of the oscillation power source 26 by the mixer 23 and amplified by the IF amplifier 25, and then an IF output signal IFout0 from the IF amplifier 25 is obtained as a human figure detection signal from the microwave sensor 100. When there is no human figure or the like in the detection area, reflected waves whose frequency is modulated are not received by the receiving antenna 21. Therefore, the IF frequency of the IF output signal IFout0 from the IF amplifier 25 is “0,” and thus a human figure detection signal is not output from the microwave sensor 100.

On the other hand, when the switching control signal S0 that is output from the switching control portion 10a is OFF, both of the switches 24a and 24b are switched to be electrically disconnected, and thus the microwave sensor 100 does not perform an operation of detecting a human figure or the like.

FIGS. 5(a) and 5(b) are examples of a time chart for comparing switching control signals S0 when two conventional microwave sensors 100 are used. FIG. 5(a) shows the switching control signal S0 of a first microwave sensor, and FIG. 5(b) shows the switching control signal S0 of a second microwave sensor.

As shown in FIGS. 5(a) and 5(b), these microwave sensors 100 perform an operation of detecting a human figure or the like intermittently at a predetermined detection cycle. The first microwave sensor 100 has a cycle T1a, and performs a detecting operation during a time T2a during which the switching control signal S0 is ON, in each cycle. The second microwave sensor 100 has a cycle T1b, and performs a detecting operation during a time T2b during which the switching control signal S0 is ON, in each cycle. The cycle of the switching control signal S0 may be set to, for example, 250 μs, and the ON time may be set to, for example, 10 μs , but the time setting is not limited to this.

When the two microwave sensors 100 are used close to each other, for example, if the timings at which the switching control signals S0 of the first microwave sensor and the second microwave sensor are ON are sufficiently apart from each other on the time axis, it can be said that their radio waves do not interfere each other and thus a normal operation is not impaired.

Furthermore, when the cycle T1a and the cycle T1b of the switching control signals S0 of the microwave sensors 100 are completely identical to each other, the timings at which the switching control signals S0 are ON are always kept at the same distance on the time axis from each other. Therefore, unless the timings at which the switching control signals S0 are ON overlap each other accidentally from the beginning, their radio waves do not interfere each other.

FIGS. 6(a) and 6(b) are examples of a time chart for comparing switching control signals S0 at a different time point from that of FIGS. 5(a) and 5(b), when two conventional microwave sensors 100 are used in a similar manner. FIG. 6(a) shows the switching control signal S0 of a first microwave sensor, and FIG. 6(b) shows the switching control signal S0 of a second microwave sensor. FIG. 7 is an example of a waveform of an IF output signal IFout0 from the IF amplifier 25 of one of the microwave sensors 100 in this case.

As described above, the cycles of the switching control signals S0 are determined by the timers 10b of the microprocessors 110, and the accuracy of time of the timers 10b depends on the accuracy of the system clocks or the clock signals CLK of the oscillation circuits 11 from which the system clocks are generated. Although the accuracy of frequency of, for example, a ceramic oscillator or a crystal oscillator used for the oscillation circuits 11 is high, there is a slight error with respect to a reference frequency, and this error is different from oscillator to oscillator. More specifically, the cycles of the switching control signals S0 are slightly different for each microwave sensor 100 in the strict sense, and the cycle T1a and the cycle T1b of the switching control signals S0 in FIGS. 6(a) and 6(b) are slightly different from each other.

Therefore, a distance on the time axis between the timings at which the switching control signals S0 of the first microwave sensor and the second microwave sensor are ON changes in a long period of time, and the timings at which the switching control signals S0 are ON almost overlap each other in the course of time as shown in FIGS. 6(a) and 6(b). In this state, their radio waves interfere each other, and thus a noise is generated. This state continues for a while, and after a further time has passed, the timings at which the switching control signals S0 are ON do not overlap each other again, and then the same process is repeated cyclically. When the noise caused by such interference between radio waves is referred to as “interference noise”, the interference noise in the IF output signal IFout0 from the IF amplifier 25 of one of the microwave sensors 100 has a waveform, for example, as shown in FIG. 7. In this example, the frequency of the interference noise is about 14 Hz.

Since the interference noise is generated in a certain cycle based on the cycle T1a and the cycle T1b of the switching control signals S0, it is possible to calculate the cycle of the interference noise or a frequency f3 of the interference noise, which is an inverse number of the cycle. When the ratio of a difference between the frequencies of the clock signals CLK of the oscillation circuits 11 of the two microwave sensors 100 is taken as “A,” and the cycle of the switching singles S0 is taken as “T1,” the frequency f3 of the interference noise can be expressed by the following equation.
f3=A/T1 (1)

When A=3530 [ppm] and T1=250 [μs] are inserted, the equation returns f3≈14.1 [Hz], which is nearly equal to the frequency of the interference noise shown in FIG. 7.

It should be noted that the ratio “A” of a difference between the frequencies of the clock signals CLK actually can take a value in a range up to about several thousands ppm in the case of, for example, a ceramic oscillator, and takes a different value from oscillator to oscillator. Therefore, the frequency of an interference noise differs based on the combination of two microwave sensors 100.

In the case where the frequency of the interference noise is within the frequency band (for example, 5 to 50 Hz) of a signal that is output when the microwave sensor 100 detects a human figure or the like, the interference noise is amplified by the IF amplifier 25, and is output as a human figure detection signal from the microwave sensor 100.

As one of means for preventing such interference between radio waves, the frequencies of microwaves emitted by microwave sensors are differentiated from each other.

Furthermore, there is also a method in which microwave sensors are electrically connected to each other to use a common synchronizing signal, so that timings of detecting operations performed by the microwave sensors do not overlap each other.

Alternatively, microwave sensors have been proposed in which the antennas of the microwave sensors are arranged to be inclined with respect to the vertical direction, so that the planes of polarization of the antennas do not overlap each other on the same plane to prevent the interference (see JP 2002-311154A, for example). The microwave sensors provided with an antenna for emitting microwaves toward a detection area and for receiving the microwaves reflected from the detection area, in which a human figure in the detection area is detected based on the microwaves received by the antenna, is characterized in that the antenna is provided to extend in an oblique direction, not in the vertical direction or the horizontal direction in the state where sensors are installed.

However, when the frequencies of the microwaves emitted by the microwave sensors are differentiated from each other as the above-described conventional technique, there is the problem of the frequency band that can be actually used being often regulated by, for example, national laws and systems. Therefore, a large number of microwave sensors using different frequencies cannot be prepared. Furthermore, when a plurality of kinds (for example, three kinds) of microwave sensors using different frequencies are prepared and used in different manners, there may be problems such as increases in the cost for, for example, production or sales management, the time and effort for, for example, inventory management at the customer side, and complicated installation work.

When microwave sensors are electrically connected to each other to use a common synchronizing signal, a wiring work becomes necessary at the time of installation. Thus, not only is the installation work difficult, but also may new problems stemming from the wiring occur (for example, a normal operation of a part of or all microwave sensors is impaired due to contact failure of wires, disconnection of wires or the like).

The method for arranging the antennas of microwave sensors to be inclined with respect to the vertical direction may be difficult to adapt in practice in some installation locations.

### SUMMARY OF THE INVENTION

In view of these issues of conventional techniques, an object of the present invention is to provide a microwave sensor in which an influence of mutual interference between the radio waves is suppressed with a simple structure so as to ensure a high reliability even when a plurality of microwave sensors are arranged close to each other, in which it is not necessary to produce a plurality of kinds of microwave sensors with different internal settings or to use them in different manners, in which there is no particular limitation regarding the installation location, and in which the installation work is easy.

In order to achieve the above-described object, the microwave sensor of the present invention that transmits microwaves toward a detection area, performs an object detecting operation based on reflected waves from an object being present in the detection area, and outputs an object detection signal based on the result of the object detecting operation comprises a detecting operation controller for letting the object detecting operation performed intermittently at a predetermined detection cycle, a random number generator for generating a random number, and a time setting changer for randomly changing time settings of the detection cycle within a predetermined range, based on the random number generated by the random number generator.

For the detection cycle, a time setting of, for example, about 250 μs can be used. The predetermined range may be 260 to 450 μs by adding a time that is determined randomly within a range of, for example, 10 to 200 μs by the time setting changer, but the time setting is not limited to this. Furthermore, it is preferable that the microwave sensor is provided with a filter for preventing signals except for signals in a frequency band (for example, 5 to 50 Hz) obtained when a human figure is detected from passing through and that only the signals in this frequency band are output to indicate detection of a human figure.

According to the microwave sensor of the present invention, even in the case where a plurality of microwave sensors are used, the probability that their detecting operations are performed accidentally at the same timing in succession is extremely low, because their detection cycles are changed randomly for each detecting operation. In the case where these microwave sensors are used close to each other, an interference noise may be generated by mutual interference between their radio waves if their detecting operations are performed at the same timing, but only when the detecting operations are performed accidentally at the same timing in succession, the frequency of the interference noise is in a relatively low frequency band of a signal that is output when a human figure or the like is detected, and thus the probability is extremely low so that it cannot become a problem in practice. Thus, a high reliability of an operation of detecting a human figure can be ensured with an influence of mutual interference between their radio waves suppressed to a negligible extent in normal use. As the microwave sensors, one kind of completely identical microwave sensors having identical internal settings is sufficient, and thus it is not necessary to produce a plurality of kinds of microwave sensors having different internal settings in advance or to use them in different manners at the time of installation, so that the cost for, for example, production and sales management can be reduced. The frequency of the microwaves that are used is only one, and thus regulations by, for example, national laws and systems do not become a problem at all. It is not necessary to wire between the microwave sensors or to arrange antennas or the like to be inclined, and thus the installation work is very easy and there is no particular limitation regarding the installation location.

Furthermore, the microwave sensor of the present invention may further comprise a passive infrared sensor for receiving an infrared ray from the detection area and detecting an intruding object based on a temperature difference from its surroundings, in which an object detection signal is allowed to be output from the microwave sensor only when the passive infrared sensor detects an object.

According to the microwave sensor of the present invention, even when the detecting operations of a plurality of microwave sensors are performed accidentally at the same timing in succession, an object detection signal is not output unless the passive infrared sensor detects an intruding object. Thus, it is possible to eliminate the possibility that erroneous output indicating detection of an objection appears although the probability is very low, and thus it is possible to use the microwave sensor in applications in which an erroneous warning is not acceptable in principle, such as crime prevention sensors.

### BRIEF DESCRIPTION OF THE DRAWINGS

FIG. 1 is a block diagram showing a circuit configuration of a microwave sensor associated with one embodiment of the present invention.

FIG. 2(a) is an example of a time chart for comparing switching control signals when two microwave sensors associated with one embodiment of the present invention are used, and shows the switching control signal of a first microwave sensor.

FIG. 2(b) is an example of a time chart for comparing switching control signals when two microwave sensors associated with one embodiment of the present invention are used, and shows the switching control signal of a second microwave sensor.

FIG. 3(a) is an example of an output waveform from an IF amplifier of one of the microwave sensors in FIG. 2, and shows an IF output signal before passing through a low-pass filter.

FIG. 3(b) is an example of an output waveform from an IF amplifier of one of the microwave sensors in FIG. 2, and shows an IF output signal after passing through a low-pass filter.

FIG. 4 is a block diagram showing a circuit configuration of a conventional microwave sensor.

FIG. 5(a) is an example of a time chart for comparing switching control signals when two conventional microwave sensors are used, and shows the switching control signal of a first microwave sensor.

FIG. 5(b) is an example of a time chart for comparing switching control signals when two conventional microwave sensors are used, and shows the switching control signal of a second microwave sensor.

FIG. 6(a) is an example of a time chart for comparing switching control signals at a different time point from that of FIG. 5 when two conventional microwave sensors are used, and shows the switching control signal of a first microwave sensor.

FIG. 6(b) is an example of a time chart for comparing switching control signals at a different time point from that of FIG. 5 when two conventional microwave sensors are used, and shows the switching control signal of a second microwave sensor.

FIG. 7 is an example of an output waveform from an IF amplifier of one of the microwave sensors in FIG. 6.

### DESCRIPTION OF THE PREFERRED EMBODIMENTS

Hereinafter, embodiments of the present invention will be described with reference to the drawings.

Structure of a Microwave Sensor

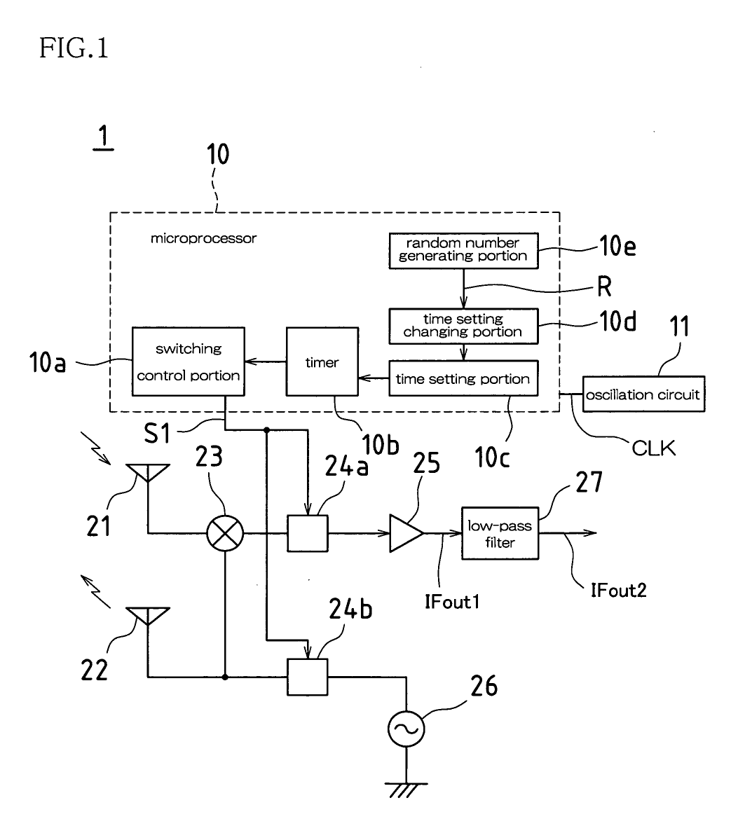

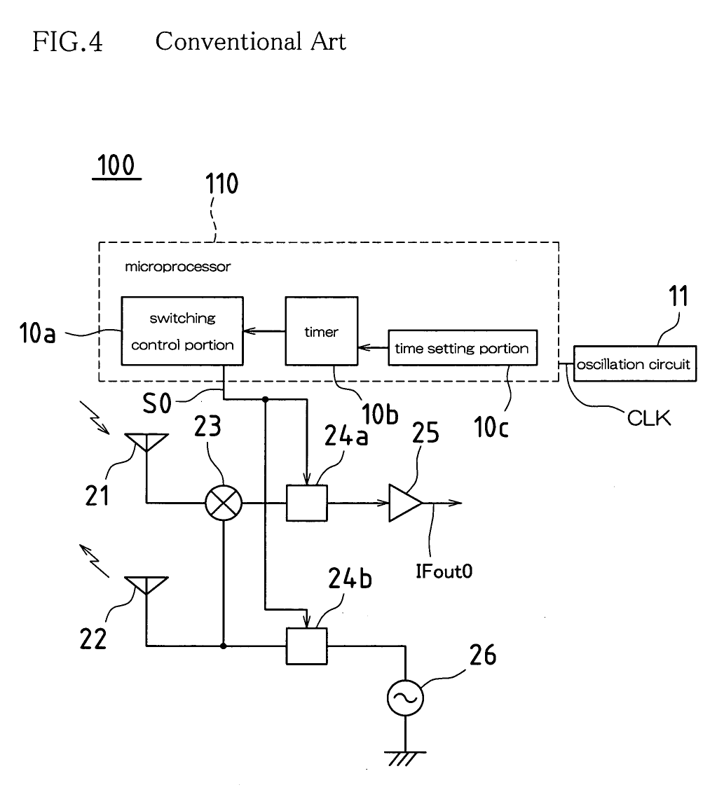

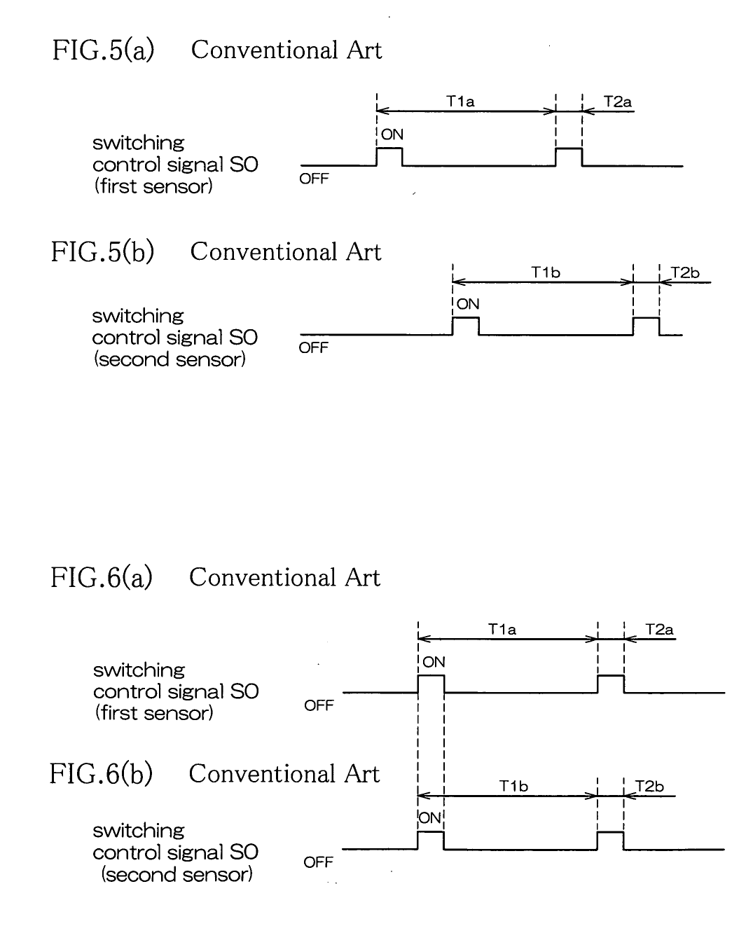

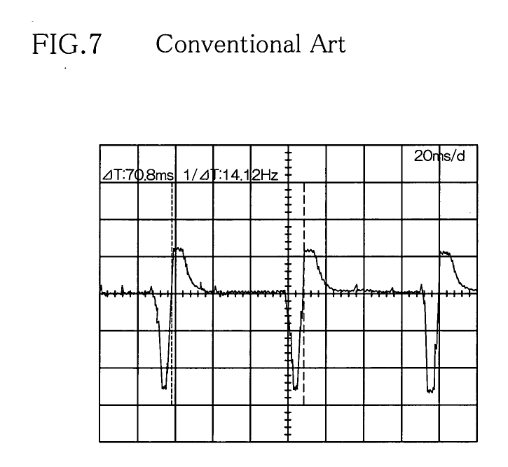

FIG. 1 is a block diagram showing a circuit configuration of a microwave sensor 1 associated with one embodiment of the present invention. The same components as in the conventional example described with reference to FIG. 4 bear the same reference numbers.

As shown in FIG. 1, the microwave sensor 1 is provided with an oscillation power source 26 for oscillating microwaves, a transmitting antenna 22 for transmitting the microwaves oscillated by the oscillation power source 26 toward a detection area, a receiving antenna 21 for receiving the reflected waves of the microwaves reflected by a human figure or the like, a mixer 23 for mixing the microwaves received by the receiving antenna 21 and the voltage waveforms of the oscillation power source 26 and outputting the result, an IF amplifier 25 for amplifying the output of the mixer 23, a low-pass filter 27 for preventing the output from the IF amplifier 25 except for signals in the frequency band obtained when a human figure or the like is detected from passing through, a microprocessor 10 for controlling the entire microwave sensor 1, and an oscillation circuit 11 for supplying a clock signal CLK to the microprocessor 10.

Herein, for the oscillation circuit 11, for example, a ceramic oscillator or a crystal oscillator can be used, but the oscillator is not limited to these.

Furthermore, a switch 24a is inserted between the mixer 23 and the IF amplifier 25, and a switch 24b is inserted between the transmitting antenna 22 and the oscillation power source 26. The switches 24a and 24b can switch an electrical connection state in response to an external signal, and are connected so as to be switchable in synchronization.

The microprocessor 10 has a switching control portion 10a for outputting a switching control signal S1 that controls switching of the switches 24a and 24b, a timer 10b for determining the cycle of the switching control signal S1 that is output from the switching control portion 10a, a time setting portion 10c for setting a detection cycle (250 μs in this embodiment) for the timer 10b, a random number generating portion 10e for generating a random number R, and a time setting changing portion 10d for changing the detection cycle that is set by the time setting portion 10c, based on the random number R that is generated by the random number generating portion 10e. Herein, the random number generating portion 10e generates integers within a range of 1 to 20 as a random number R with equal probability, and the time setting changing portion 10d adds R×10 μs to the detection cycle that is set by the time setting portion 10c. For example, the timer 10b is set to 260 μs by adding 10 μs when R=1, and the timer 10b is set to 450 μs by adding 200 μs when R=20. These detection cycles and the method for changing the detection cycles are to be considered in all respects as illustrative and not limiting. For the ON time of the switching control signal S1 in each cycle, a necessary time can be ensured by using, for example, another timer (not shown) or a software timer.

When the switching control signal S1 that is output from the switching control portion 10a is ON, both of the switches 24a and 24b are switched to be electrically connected, and thus the microwave sensor 1 performs an operation of detecting a human figure or the like. More specifically, microwaves are transmitted from the transmitting antenna 22 toward a detection area, and when a human figure or the like is present in the detection area, the reflected waves from the human figure with the frequency modulated due to the Doppler effect are received by the receiving antenna 21. The received reflected waves are mixed with the voltage waveforms of the oscillation power source 26 by the mixer 23, and amplified by the IF amplifier 25. Among an IF output signal IFout1 from the IF amplifier 25, an IF output signal IFout2 that has passed through the low-pass filter 27 is obtained as a human figure detection signal from the microwave sensor 1. When there is no human figure or the like in the detection area, reflected waves whose frequency is modulated are not received by the receiving antenna 21. Therefore, the IF frequency of the IF output signal IFout2, which is obtained after the IF output signal IFout1 from the IF amplifier 25 passes through the low-pass filter 27, is “0,” and thus a human figure detection signal is not output from the microwave sensor 1.

On the other hand, when the switching control signal S1 that is output from the switching control portion 10a is OFF, both of the switches 24a and 24b are switched to be electrically disconnected, and thus the microwave sensor 1 does not perform an operation of detecting a human figure or the like.

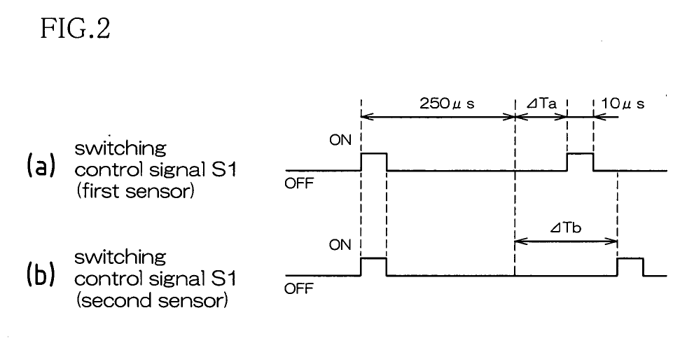

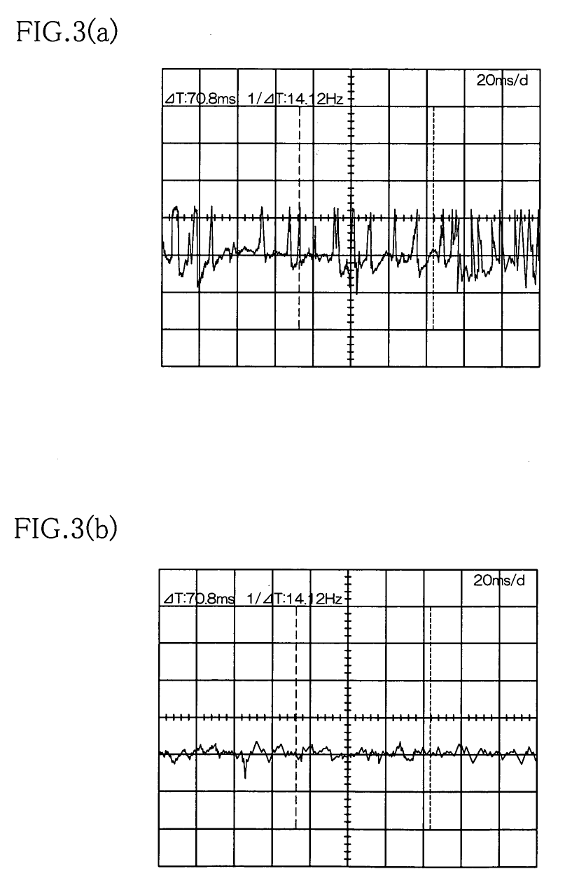

Example of a case where two microwave sensors are used FIGS. 2(a) and 2(b) are examples of a time chart for comparing switching control signals S1 when two microwave sensors 1 associated with one embodiment of the present invention are used. FIG. 2(a) shows the switching control signal S1 of a first microwave sensor, and FIG. 2(b) shows the switching control signal S1 of a second microwave sensor. FIGS. 3(a) and 3(b) are examples of an output waveform from the IF amplifier 25 of one of the microwave sensors 1 in this case. FIG. 3(a) shows an IF output signal IFout1 before passing through the low-pass filter 27, and FIG. 3(b) shows an IF output signal IFout2 after passing through the low-pass filter 27.

As shown in FIGS. 2(a) and 2(b), these microwave sensors 1 perform an operation of detecting a human figure or the like intermittently at a predetermined detection cycle. In the first microwave sensor 1, when a time added at the time setting changing portion 10d is taken as ΔTa, the detection cycle is “250+ΔTa” [μs]. In the second microwave sensor 1, when a time added at the time setting changing portion 10d is taken as ΔTb, the detection cycle is “250+ΔTb” [μs].

When the two microwave sensors 1 are used close to each other, if the detection cycles of the two microwave sensors 1 overlap each other on the time axis, an interference noise that is almost equal to the detection cycle is generated, and the IF output signal IFout1 from the IF amplifier 25 has a waveform, for example, as shown in FIG. 3(a). For example, an interference noise of about 3.84 kHz is generated when the detection cycle is 260 μs, and an interference noise of about 2.22 kHz is generated when the detection cycle is 450 μs, and the frequency of the interference noise changes moment by moment. However, these frequencies are sufficiently apart from the frequency band (for example, 5 to 50 Hz) of a signal that is output when a human figure or the like is detected, and can be prevented from passing through the low-pass filter 27. The IF output signal IFout2 after passing through the low-pass filter 27 has a waveform, for example, as shown in FIG. 3(b), and the interference noise has been eliminated almost completely.

However, the detection cycles of the microwave sensors 1 are determined based on the random numbers R generated at the random number generating portions 10e, there is a possibility that the cycles of the microwave sensors 1 overlap each other on the time axis in succession, although the probability is very low. In this case, the frequency of the interference noise becomes gradually low, and it cannot be said that there is completely no possibility of the interference noise to pass through the low-pass filter 27 and appear in the IF output signal IFout2. For example, when the detection operations overlap each other 8 times in succession, the frequency of the interference noise is 8×260 μs=2.08 ms (about 481 Hz) when the detection cycle is 260 μs, and the frequency of the interference noise is 8×450 μs=3.6 ms (about 278 Hz) when the detection cycle is 450 μs. These frequencies are close to the upper limit of the frequency band of a signal that is output when a human figure or the like is detected, so that the interference noise may appear in the IF output signal IFout2.

Thus, the probability of this state to happen is estimated in order to judge whether or not this becomes a problem in practice. The probability that the detecting operations overlap each other once is 1/20, because each of ΔTa and ΔTb can have 20 values with equal probability. Therefore, the probability that the detection operations overlap each other 8 times in succession is 1/20⁸≈3.9×10⁻¹¹, and the probability is extremely small. When the expected value of the time that is necessary for this coincidence to happen once is calculated based on the detection cycle, 260 μs×20⁸=6,656,000 seconds≈110,933 minutes≈1,849 hours≈77 days results, even in the case where the detection cycle is 260 μs, which is the shortest.

As described above, the probability that erroneous output appears in the IF output signal IFout2 although a human figure or the like is not detected is extremely small, and thus it does not become a problem at all, depending on the purpose of use or applications. For example, when the microwave sensor 1 is used for automated cleaning of an urinal in the gentlemen's toilet, the problem, if any, is that a small amount of water flows for excessive cleaning only occasionally.

In the above explanation, the case where two microwave sensors 1 are used close to each other has been described, but even in the case where three or more microwave sensors are used, the probability that their detection cycles overlap one another in succession is sufficiently low, and thus it does not become a problem at all, depending on the purpose of use or applications.

According to the above-described structure of this embodiment, even in the case where a plurality of microwave sensors 1 are used close to each other, the detection cycle of the switching control signal S1 of each of the microwave sensors 1 is changed randomly in each detecting operation, and thus the probability that an influence of mutual interference between their radio waves occurs is suppressed extremely low so that it cannot become a problem in practice. As the microwave sensors 1, one kind of completely identical microwave sensors having identical internal settings is sufficient. Thus, it is not necessary to produce a plurality of kinds of microwave sensors having different internal settings in advance or to use them in different manners at the time of installation, so that the cost for, for example, production and sales management can be reduced. As the frequencies of the microwaves used by the microwave sensors 1, only common one frequency is sufficient, and thus regulations by, for example, national laws and systems do not become a problem at all. It is not necessary to wire between the microwave sensors 1, or to arrange antennas or the like to be inclined, and thus the installation work is very easy.

Other Usage Examples and Modified Examples

Furthermore, the microwave sensor 1 can be further provided with a passive infrared sensor in which an infrared ray from a human figure in a detection area is received, and the intruder is detected based on a temperature difference between the human figure and its surroundings, and the AND of the detection outputs of the sensors can be regarded as an output indicating detection of a human figure (a human figure detection signal is allowed to be output from the microwave sensor 1 only when the passive infrared sensor detects a human figure), so that the reliability of human figure detection is enhanced. It should be noted that the detection area of the microwave sensor 1 and the detection area of the passive infrared sensor do not overlap each other in the strict sense, but it is desirable that the main portions of these detection areas overlap each other to the extent possible.

According to this example, it is possible to eliminate the above-described possibility that erroneous output indicating detection of a human figure appears although the probability is very low, and thus it is possible to use the microwave sensor in applications in which an erroneous warning is not acceptable in principle, such as crime prevention sensors.

The invention may be embodied in other forms without departing from the spirit or essential characteristics thereof The embodiment disclosed in this application is to be considered in all respects as illustrative and not limiting. The scope of the invention is indicated by the appended claims rather than by the foregoing description, and all changes which come within the meaning and range of equivalency of the claims are intended to be embraced therein.

1. A microwave sensor that transmits microwaves toward a detection area, performs an object detecting operation based on reflected waves from an object being present in the detection area, and outputs an object detection signal based on a result of the object detecting operation, the microwave sensor, comprising:
a detecting operation controller for letting the object detecting operation performed intermittently at a predetermined detection cycle,
a random number generator for generating a random number, and
a time setting changer for randomly changing time settings of the detection cycle within a predetermined range, based on the random number generated by the random number generator.

2. The microwave sensor according to claim 1, comprising:
a filter for preventing output except for signals in a frequency band obtained when a human figure is detected from passing through.

3. The microwave sensor according to claim 1, further comprising:
a passive infrared sensor that receives an infrared ray from the detection area, and detects an intruding object based on a temperature difference from its surroundings,
wherein an object detection signal is allowed to be output from the microwave sensor only when the passive infrared sensor detects an intruding object.

4. The microwave sensor according to claim 2, further comprising:
a passive infrared sensor that receives an infrared ray from the detection area, and detects an intruding object based on a temperature difference from its surroundings,
wherein an object detection signal is allowed to be output from the microwave sensor only when the passive infrared sensor detects an intruding object.
